(19) United States
(12) Patent Application Publication
(10) Pub. No.: US 2024/0123874 A1
(43) Pub. Date: Apr. 18, 2024

(54) ROTATABLE SEAT WITH LOGIC FOR A VEHICLE

(71) Applicant: Ford Global Technologies, LLC, Dearborn, MI (US)

(72) Inventors: Marcos Silva Kondrad, Macomb Township, MI (US); Patrick Maloney, Livonia, MI (US); Kevin VanNieulande, Fraser, MI (US); Kevin Wayne Preuss, Berkley, MI (US); Johnathan Andrew Line, Northville, MI (US)

(73) Assignee: Ford Global Technologies, LLC, Dearborn, MI (US)

(21) Appl. No.: 17/965,142

(22) Filed: Oct. 13, 2022

(51) Int. Cl. B60N 2/14; B60N 2/02

(52) U.S. Cl. CPC B60N 2/143; B60N 2/0232; B60N 2/0252; B60N 2002/0272

(57) ABSTRACT

A system for reconfiguring a seating assembly within a vehicle, the system comprising identifying an adjacent surface within an interior of the vehicle, calculating a distance between the seating assembly and the adjacent surface, wherein the configuration is an occupiable seating configuration, and further wherein the occupiable seating configuration has a mode chosen from a forward facing mode and a rearward facing mode, storing the distance between the seating assembly and the adjacent surface, receiving a user input to transition the seating assembly from one occupiable seating configuration mode chosen from the forward facing mode and the rearward facing mode toward the other mode, and controlling the configuration of the seating assembly to transition from one occupiable seating configuration mode chosen from the forward facing mode and the rearward facing mode toward the other of the forward facing mode and the rearward facing mode.

### FIELD OF THE DISCLOSURE

The present disclosure generally relates to a seating assembly, that and more particularly, relates to seating controls that transition a seating assembly between a forward facing mode and a rearward facing mode within a vehicle.

### BACKGROUND OF THE DISCLOSURE

Vehicles may be assembled to accommodate a rotatable seating assembly. In particular, a dash, a pillar, a console, etc. may be modified to allow the rotatable seating assembly to fully rotate to and from target facing modes. Rotatable seating assemblies can rotate to a dash, a pillar, a console, etc. and further rotation may be limited. Accordingly, further enhanced movement of the seating assembly may be desired.

### SUMMARY OF THE DISCLOSURE

According to one aspect of the present disclosure, a seating assembly for a vehicle is provided. The seating assembly includes a seat, a seatback, an actuator, a sensor configured to sense an adjacent surface of the vehicle, and a controller configured to receive adjacent surface data from the sensor. The controller is further configured to actuate the actuator to rotate the seating assembly between a forward facing mode and a rearward facing mode past the adjacent surface.

Embodiments of the first aspect of the disclosure can include any one or a combination of the following features:
the seating assembly further comprises a swiveling assembly comprises a mounting plate coupled with a slide track, a base plate coupled with an interior floor of the vehicle, and a swivel ring extending between the mounting plate and the base plate, wherein the swivel ring is coupled with a underside of the mounting plate, and further wherein the swivel ring is coupled with a top side of the base plate;
the seating assembly further comprises a sliding assembly comprising the slide track, wherein the seating assembly slides along the slide track;
the seating assembly further comprises a lifting assembly comprising the slide track, a seat bracket, and a lift arm extending between the slide track and the seat bracket, wherein the lift arm is coupled with the slide track and the seat bracket;
the seating assembly further comprises a pivot member extending between the seat and the seatback, wherein the pivot member is coupled with the seat, and further wherein the pivot member is coupled with the seatback;
the controller is configured to receive data of the adjacent surface from the sensor, and further wherein the controller stores the data in a memory;
the sensor comprises an imaging device configured to sense the adjacent surface via image capture;
the sensor senses the interior structure when the seating assembly arrives at the adjacent surface; and
the sensor is operatively coupled with the actuator, and wherein the sensor senses when the actuator partially transitions the seating assembly between the forward facing mode and the rearward facing mode.

According to another aspect of the present disclosure, a seating assembly for a vehicle is provided. The seating assembly includes a pivoting assembly comprising a seatback coupled with a pivot member, and a seat coupled with a pivot member. The pivot member is coupled with a first actuator. The seating assembly also comprises a lifting assembly comprising a slide track, a seat bracket, and a lift arm extending between the slide track and the seat bracket. The lift arm is coupled with the slide track, the seat bracket, and a second actuator. The seating assembly also comprises a sliding assembly comprising the slide track, wherein the slide track is coupled with a third actuator. The seating assembly also comprises a swiveling assembly comprising a mounting plate coupled with the slide track, a base plate coupled with the vehicle, a swivel ring extending between the mounting plate and the base plate, wherein the swivel ring is coupled with a fourth actuator, wherein the swivel ring is coupled with a underside of the mounting plate, and further wherein the swivel ring is coupled with a top side of the base plate. The seating assembly also comprises a sensor configured to sense an adjacent surface of the vehicle, and a controller configured to receive adjacent surface data from the sensor, wherein the controller is configured to control the first actuator, the second actuator, the third actuator to transition the seating assembly from an initial mode along a configuration path toward a target mode, and wherein the controller is configured to store the data of the adjacent surface of the vehicle in a memory.

Embodiments of the second aspect of the disclosure can include any one or a combination of the following features:
the seating assembly further comprises an intermediate plate defining an aperture, wherein the swivel ring is disposed within the aperture of the intermediate plate;
the sensor comprises an imaging device configured to sense the adjacent surface via image capture;
the sensor senses the adjacent surface when the seating assembly arrives at the adjacent surface; and
the sensor is operatively coupled with at least one of the first actuator, the second actuator, the third actuator, the fourth actuator, and the adjacent surface.

According to yet another aspect of the present disclosure, a method for transitioning a seating assembly between a forward facing mode and a rearward facing mode is disclosed. The method comprising identifying an adjacent surface within an interior of the vehicle in sensor data, calculating a distance between the seating assembly and the adjacent surface in response to the seating assembly having a configuration, wherein the configuration is an occupiable seating configuration, and further wherein the occupiable seating configuration has a mode chosen from a forward facing mode and a rearward facing mode, storing the distance between the seating assembly and the adjacent surface, receiving a user input to transition the seating assembly from an initial mode chosen from the forward facing mode and the rearward facing mode toward a target mode opposite of the initial mode, and controlling the configuration of the seating assembly to transition from one occupiable seating configuration mode chosen from the forward facing mode and the rearward facing mode toward the other of the forward facing mode and the rearward facing mode.

Embodiments of this aspect of the disclosure may include any one or a combination of the following features or steps:
identifying the adjacent surface within image data, wherein the sensor is an image capturing sensor;
detecting which mode of the forward facing mode and the rearward facing mode is present, and in response to the mode being detected, activating a mode-specific transition of the seating assembly;
identifying the adjacent surface in sensor data in response to the seating assembly of a first configuration arriving at the adjacent surface;
controlling the configuration of the seating assembly by controlling at least one of a seatback, a seat, an armrest, a headrest, a slide track, a lift arm, and swivel ring; and
controlling the configuration of the seating assembly to a second configuration in response to the seating assembly arriving at the adjacent surface.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a side perspective view of a seating assembly in a forward facing mode and an occupiable seating configuration;

FIG. 2 is a side perspective view of the seating assembly in a forward facing mode and a transitioning configuration;

FIG. 3 is a side perspective view of the seating assembly in the transitioning configuration between the forward facing mode and a rearward facing mode on a configuration path;

FIG. 4 is a side perspective view of the seating assembly in the rearward facing mode and the transitioning configuration;

FIG. 5 is a side perspective view of the seating assembly in the rearward facing mode and the occupiable seating configuration;

FIG. 6 is a front perspective view of the seating assembly exploded;

FIG. 7 is a block diagram illustrating a controller for controlling the seating assembly;

FIG. 8 is a flow chart illustrating a method of transitioning a seating assembly between a forward facing mode and a rearward facing mode; and

FIG. 9 is a flow chart demonstrating a method of transitioning a seating assembly between a forward facing mode and a rearward facing mode.

### DETAILED DESCRIPTION OF THE PREFERRED EMBODIMENTS

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

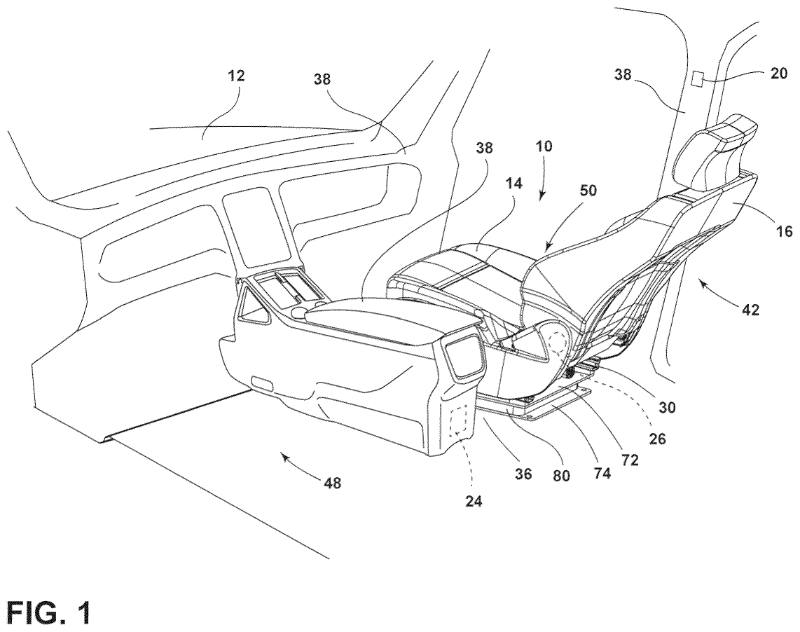

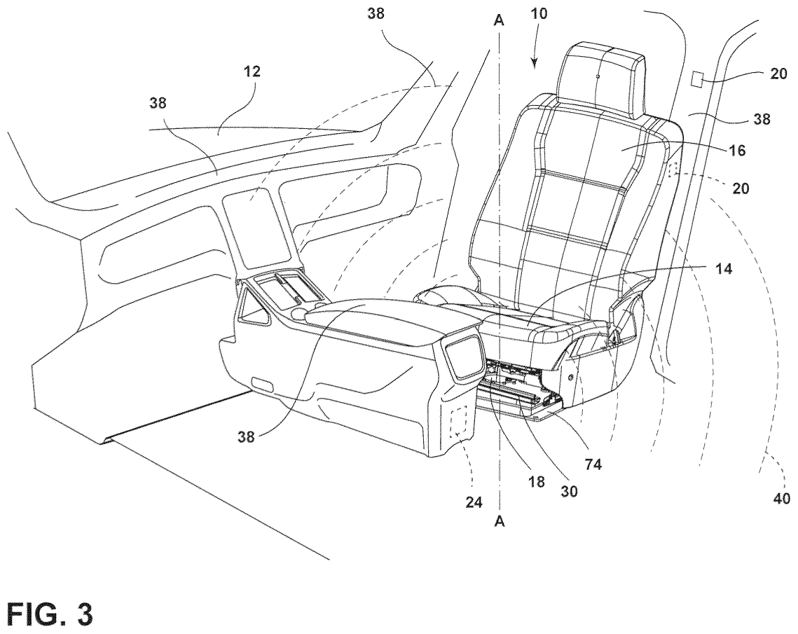

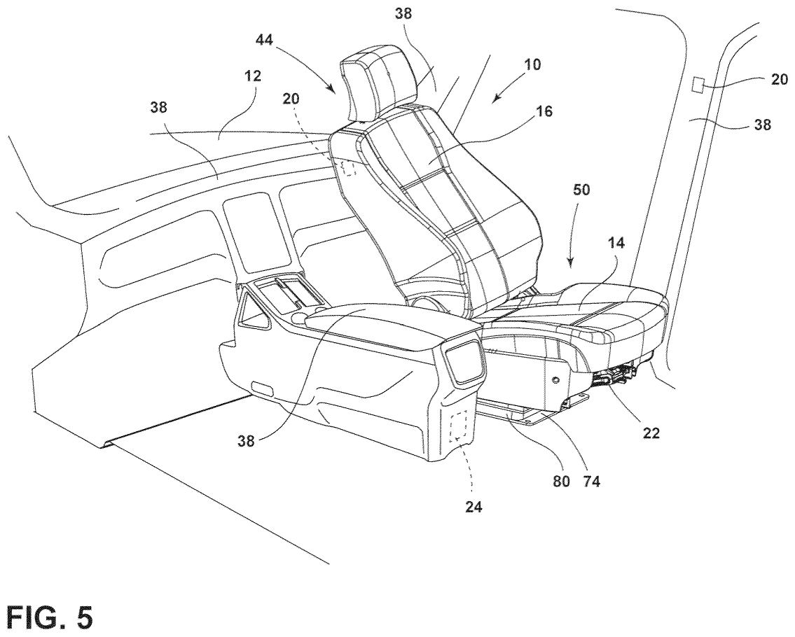

Referring to FIGS. 1-8, reference numeral 10 generally designates a seating assembly.

The seating assembly 10 may be positioned within a vehicle 12. For example, the seating assembly 10 may be positioned within a passenger compartment 36 of the vehicle 12. The vehicle 12 may be a motor vehicle. For example, the vehicle 12 may be a land-based vehicle (e.g., an automobile, a motorcycle, a train, etc.), an air-based vehicle (e.g., an airplane, a helicopter, etc.), and/or a water-based vehicle (e.g., a boat or other watercraft). While the vehicle 12 may be a motor vehicle, the present disclosure is not limited to internal combustion engines as a source of locomotive power for the vehicle 12. Rather, alternative sources may be utilized in providing locomotive power to the vehicle 12. For example, locomotive power may be provided to the vehicle 12 by electric motors, fuel cells, and/or petroleum-based fuel engines. According to various examples, the vehicle 12 may be driver-controlled, semi-autonomous, fully-autonomous, or any combination of user-controlled and automated. For example, the semi-autonomous example of the vehicle 12 may perform many, or all, commuting functions (e.g., accelerating, braking, turning, signaling, etc.) independent of user interaction while the user maintains override control of the vehicle 12.

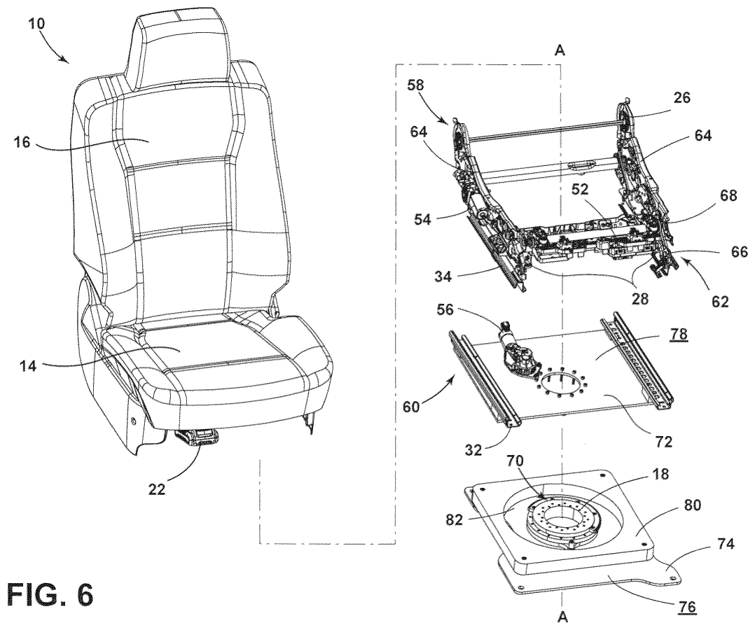

Referring now to FIGS. 1-6, the seating assembly 10 includes at least a seat 14, a seatback 16, a swivel ring 18, at least one sensor 20, a first actuator 22, and a controller 24. The seating assembly 10 may also preferably include a pivot member 26, a lift arm 28, and a slide track 30, as exemplified in at least FIG. 6. The slide track 30 comprises a receiving track 32 slidably coupled with an insertion track 34. The swivel ring 18 is indirectly coupled with the seat 14. The swivel ring 18 enables rotational movement of the seat 14 and all elements of the seating assembly 10 coupled with the seat 14 about a vertical A-axis. While the swivel ring 18 allows for different seating orientations, modern OEMs of passenger vehicles would currently warn against employing some alternative uses for the passenger compartment 36 while the vehicle 12 is in motion; however it is anticipated that technology and the regulatory framework may evolve in the future to where such an activity is safe and permissible.

Referring to FIGS. 1-9, the controller 24 is configured to receive position data of an adjacent surface 38. The controller 24 may be configured to derive a configuration path 40 for the seating assembly 10 to transition between a forward facing mode 42 and a rearward facing mode 44. Deriving the configuration path 40 may include a variety of steps including detecting and compensating for a plurality of adjacent surfaces 38 in order to control the seating assembly 10 to adjust into a transitioning configuration 46. The adjacent surface 38 may be a surface of a center console, a pillar, a dash, a separate seating assembly, a door, a cooler, a wall, and/or other conceivable adjacent surface 38 within an interior 48 of the vehicle 12. The controller 24 controls the seating assembly 10 to reconfigure from an occupiable seating configuration 50 to the transitioning configuration 46 in order for the seating assembly 10 to follow the configuration path 40. The occupiable seating configuration 50 and the transitioning configuration 46 may be the same configuration depending on at least the configuration path 40. The controller 24 may actuate a plurality of actuators (22, 52, 54, 56) simultaneously or at different times to reconfigure the seating assembly 10 between the occupiable seating configuration 50 and the transitioning configuration 46. The plurality of actuators (22, 52, 54, 56) may be electromechanical motors, solenoids, hydraulic motors, other similar means of actuation, or a combination thereof. A plurality of actuators including the first actuator 22, a second actuator 52, a third actuator 54, and a fourth actuator 56 may actuate each of the seatback 16, the seat 14, a headrest, the slide track 30, the lift arm 28, the swivel ring 18, respectively. The plurality of actuators may also actuate an armrest, or various members that may be implemented or incorporated as a part of the seating assembly 10.

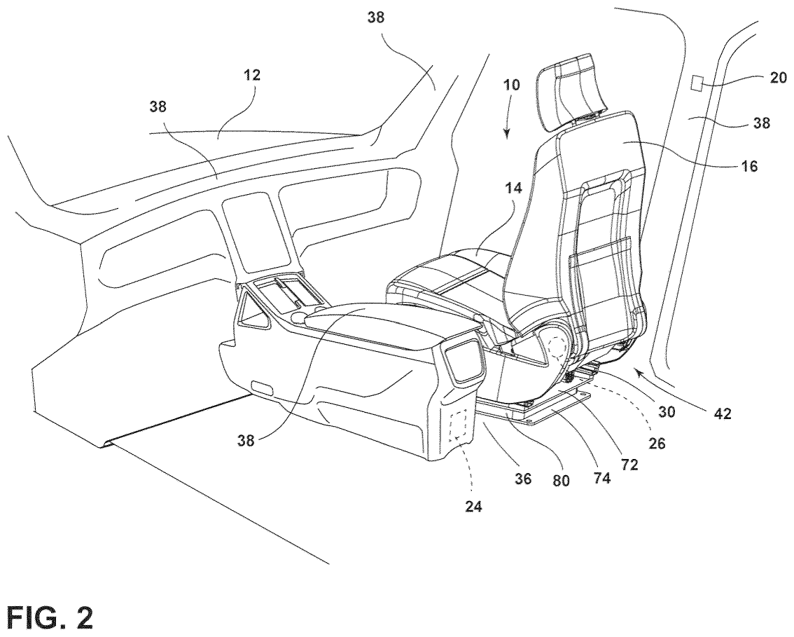

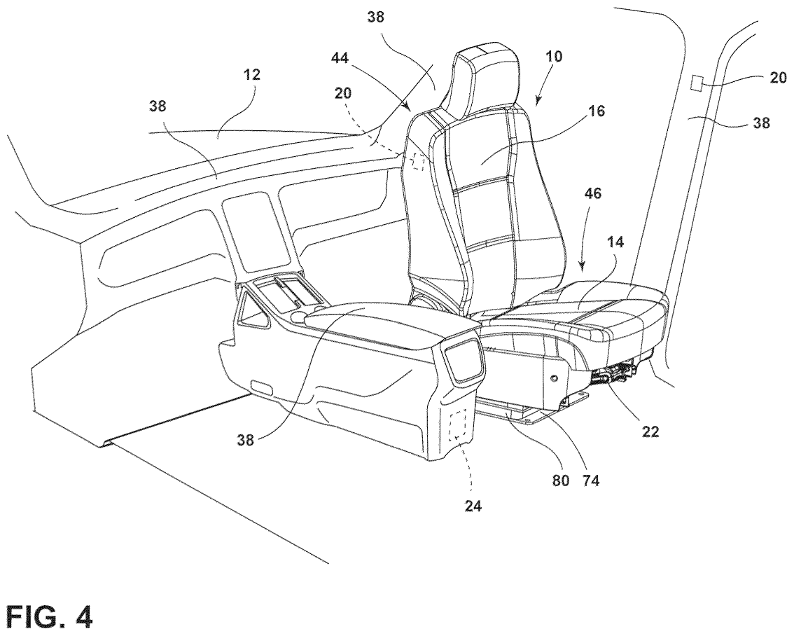

Referring to at least FIG. 2, FIG. 4, and FIG. 6, a pivoting assembly 58 comprises the pivot member 26, the seat 14, the seatback 16, and a first actuator 22 of the plurality of actuators (22, 52, 54, 56). The pivot member 26 is coupled with the seat 14 and the seatback 16 such that the relative angle between the seat 14 and the seatback 16 varies based on actuation of the first actuator 22. Activation of the first actuator 22 of the pivoting assembly 58 may correspond to having the configuration path 40 end where the seating assembly 10 is delivered at the opposite of the forward facing mode 42 and the rearward facing mode 44 instead of at the adjacent surface 38. A sliding assembly 60 comprises the slide track 30, wherein the slide track 30 is coupled with a third actuator 54. The third actuator 54 slides the insertion track 34 relative to the receiving track 32 and vice versa. Activation of the sliding assembly 60 may occur in response to activation of a combination of the other assemblies ending the configuration path 40 at the adjacent surface 38 instead of at the opposite of the forward facing mode 42 and the rearward facing mode 44.

Referring to FIG. 6, the seating assembly 10 may comprise a lifting assembly 62. The lifting assembly 62 may comprise the lift arm 28, the insertion track 34, a seat bracket 64, and a second actuator 52. The lift arm 28 extends between the insertion track 34 and the seat bracket 64. The lift arm 28 is coupled with the insertion track 34 at a first end 66 and coupled with the seat bracket 64 and a second end 68. The lift arm 28 is also coupled with the second actuator 52, such that actuation of the second actuator 52 changes the relative distance between the insertion track 34 and the seat bracket 64. The seat 14 is coupled with the seat bracket 64. Activation of the lifting assembly 62 increases or decreases the vertical position of the seat 14 relative to the interior 48 of the vehicle 12. Activation of the second actuator 52 of the lifting assembly 62 may correspond to having the configuration path 40 end where the seating assembly 10 is delivered at the opposite of the forward facing mode 42 and the rearward facing mode 44 instead of at the adjacent surface 38. Activation of the lifting assembly 62 may occur simultaneously to activation of the pivoting assembly 58. Activation of the lifting assembly 62 may occur in response to activation of the pivoting assembly 58 ending the configuration path 40 at the adjacent surface 38 instead of at the opposite of the forward facing mode 42 and the rearward facing mode 44. Activation of the sliding assembly 60 may occur in response to activation of a combination of the other assemblies ending the configuration path 40 at the adjacent surface 38 instead of at the opposite of the forward facing mode 42 and the rearward facing mode 44. Activation of the lifting assembly 62 may occur before activation of any other assembly comprising one actuator of the plurality of actuators (22, 52, 54, 56).

Referring to FIGS. 1-6, the seating assembly 10 may comprise a sliding assembly 60. The sliding assembly 60 may comprise the slide track 30 and a third actuator 54. The slide track 30 has a direction of extension. Actuation of the third actuator 54 slides the insertion track 34 within the receiving track 32 along the direction of extension of the slide track 30. Activation of the second actuator 52 of the lifting assembly 62 may correspond to having the configuration path 40 end where the seating assembly 10 is delivered at the opposite of the forward facing mode 42 and the rearward facing mode 44 instead of at the adjacent surface 38. Activation of the lifting assembly 62 may occur simultaneously to activation of the pivoting assembly 58. Activation of the sliding assembly 60 may occur in response to activation of the pivoting assembly 58 ending the configuration path 40 at the adjacent surface 38 instead of at the opposite of the forward facing mode 42 and the rearward facing mode 44. Activation of the sliding assembly 60 may occur in response to activation of the lifting assembly 62 ending the configuration path 40 at the adjacent surface 38 instead of at the opposite of the forward facing mode 42 and the rearward facing mode 44. Activation of the sliding assembly 60 may occur in response to activation of a combination of the other assemblies ending the configuration path 40 at the adjacent surface 38 instead of at the opposite of the forward facing mode 42 and the rearward facing mode 44. Activation of the lifting assembly 62 may occur before activation of any other assembly comprising one actuator of the plurality of actuators (22, 52, 54, 56).

Referring to FIG. 6, the seating assembly 10 comprises a swiveling assembly 70. The swiveling assembly 70 includes the swivel ring 18, a mounting plate 72, a base plate 74, an intermediate plate 80, and a fourth actuator 56. The swivel ring 18 is coupled with a top side 76 of the base plate 74. The swivel ring 18 is coupled with an underside 78 of the mounting plate 72. The swivel ring 18 extends between the base plate 74 and the mounting plate 72. The intermediate plate 80 defines an aperture 82. The swivel ring 18 is disposed within the aperture 82 of the intermediate plate 80. The intermediate plate 80 extends between the base plate 74 and the mounting plate 72. In response to activation of the swiveling assembly 70, the mounting plate 72 rotates about a vertical A-axis. The swiveling assembly 70 may be activated in response to at least one of the pivoting assembly 58, the lifting assembly 62, and the sliding assembly 60 allowing the configuration path 40 to end at the opposite of the forward facing mode 42 and the rearward facing mode 44. The swiveling assembly 70 swivels the seating assembly 10 clockwise or counterclockwise.

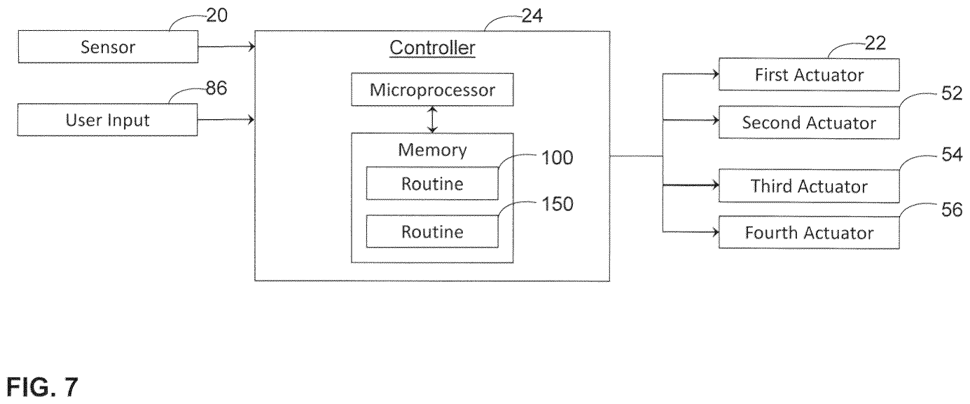

Referring now to FIG. 7, the seat controller 24 is illustrated having a microprocessor in communication with a memory. The memory is illustrating having routines stored (100, 150). The controller 24 is in communication with the first actuator 22, the second actuator 52, the third actuator 54, and the fourth actuator 56. The controller 24 controls each actuator of the plurality of actuators (22, 52, 54, 56). The sensor 20 is illustrated in communication with the controller 24. The sensor 20 provides location data of the adjacent surface 38 and/or location data of the seating assembly 10. The controller 24 is also in communication with the user 86 input, as the controller 24 receives input from the user 86 to transition from the initial mode, chosen from one of the forward facing mode 42 and the rearward facing mode 44, toward the target mode which is the mode opposite of the initial mode. The controller 24 may include analog and/or digital circuitry.

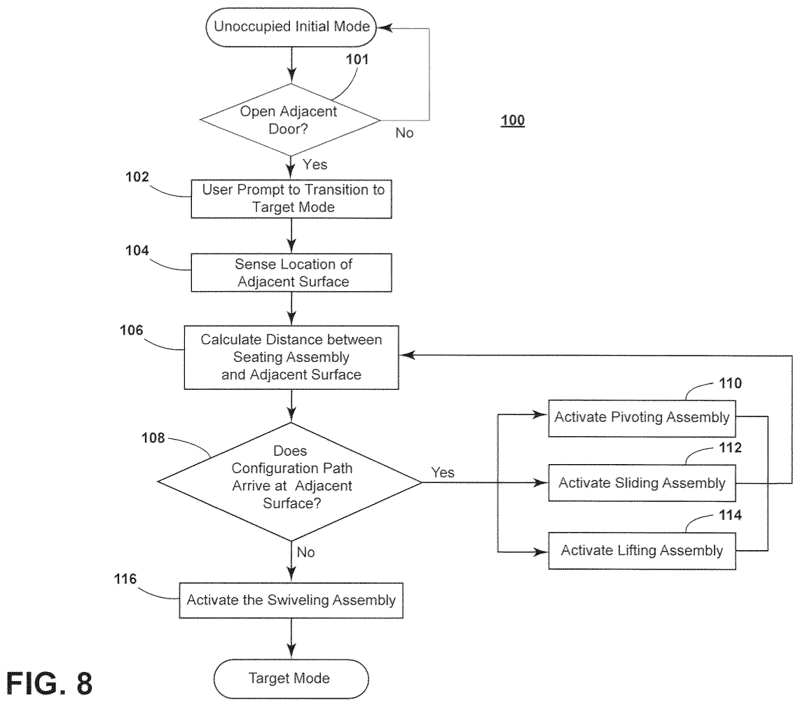

Referring now to FIG. 8, the flow chart demonstrates a first method of transitioning 100 the seating assembly 10. The first method of transitioning 100 may interchange the forward facing mode 42 for the rearward facing mode 44 and vice versa, so long as each mode transitions to the opposite mode of the forward facing mode 42 and the rearward facing mode 44. In other words, the method starts with the seating assembly in an initial mode and ends with the seating assembly in a target mode. According to some embodiments the first method of transitioning 100 may relate to transitioning the seating assembly 10 between the forward facing mode 42 and the rearward facing mode 44 when a door adjacent to the seating assembly 10 is in an open position. Additionally, or alternatively, the first method of transitioning 100 may comprise the step of detecting whether the seating assembly 10 is occupied (e.g., occupant classification system (OCS) mat, pressure sensor, etc.). When the seating assembly 10 is unoccupied, the first method of transitioning 100, may continue. The first method of transitioning 100 the seating assembly 10 comprises the step 102 of prompting the seating assembly 10 to transition to the opposite of the forward facing mode 42 and the rearward facing mode 44. The prompting can come from input such as a user speaking into a microphone, a user interacting with a human-machine interface (HMI), a user activating a switch, etc. The first method of transitioning 100 also comprises a step 104 of sensing the location of the adjacent surface 38. The sensor 20 may be an imaging device that senses via image capture. The sensor 20 may be interchangeable with a radar sensor, laser sensor, ultrasonic sensor, inductive, or various sensory devices that may be implemented or incorporated within the interior 48 of the vehicle 12. The step 104 of the controller 24 sensing the location of the adjacent surface 38 may, alternatively or additionally, include sensing the location and mode of the seating assembly 10. The first method of transitioning 100 also comprises a step 106 of the controller 24 calculating the distance between the seating assembly 10 and the adjacent surface 38. The first method of transitioning 100 also compromises a step 108 of the controller 24 determining, based on the calculations of the step 106, whether the seating assembly 10, that is in a current configuration chosen from one of the occupiable seating configuration 50 and the transitioning configuration 46, will arrive at the adjacent surface 38 or the target mode (e.g., the forward facing mode 42 or rearward facing mode 44).

Still referring to FIG. 8, the first method of transitioning 100 also comprises a step 110 of activating the pivoting assembly 58, in response to the controller 24 determining that the seating assembly 10 will arrive at the adjacent surface 38. In one example, the step 110 of activating the pivoting assembly 58 changes the relative angle between the seat 14 and the seatback 16 to allow the configuration path 40 to end at the target mode (e.g., the forward facing mode or the rearward facing mode).

In further reference to FIG. 8, the first method of transitioning 100 comprises a step 112 of activating the lifting assembly 62, in response to the controller 24 determining that the seating assembly 10 will arrive at the adjacent surface 38. The step 112 of activating the lifting assembly 62, in one example, changes the vertical position of the seating assembly 10 to allow the configuration path 40 to end at the target mode (e.g., the forward facing mode 42 or the rearward facing mode 44). The step 112 may occur simultaneously to the step 110, as exemplified in FIG. 8. The step 112 may occur before the step 110. The step 112 may occur after the step 110.

In even further reference to FIG. 8, the first method of transitioning 100 comprises a step 114 of activating the sliding assembly 60, in response to the controller 24 determining that the seating assembly 10 will arrive at the adjacent surface 38. The step 114 of activating the sliding assembly 60, in one example, slides the seating assembly 10 along the direction of extent of the slide track to allow the configuration path 40 to end at the target mode (e.g., the forward facing mode 42 or the rearward facing mode 44). The step 114 may occur simultaneously to the step 110 and the step 112, as exemplified in FIG. 7. The step 114 may occur before the step 110 and the step 112. The step 114 may occur between the step 110 and the step 112. In other words, the step 110, the step 112, and the step 114 may occur simultaneously or in an order that allows the configuration path 40 to end at the target mode (e.g., the forward facing mode 42 or the rearward facing mode 44). The first method of transitioning 100 comprises a step 116 of activating the swiveling assembly 70. As exemplified in FIG. 7, the step 116 occurs in response to the configuration path 40 ending at the target mode (e.g., the forward facing mode 42 or the rearward facing mode 44). FIG. 8 demonstrates one example of the first method of transitioning 100 comprising an end of the rearward facing mode 44. Alternatively, the first method of transitioning 100 may end in the opposite of the rearward facing mode 44, the forward facing mode 42.

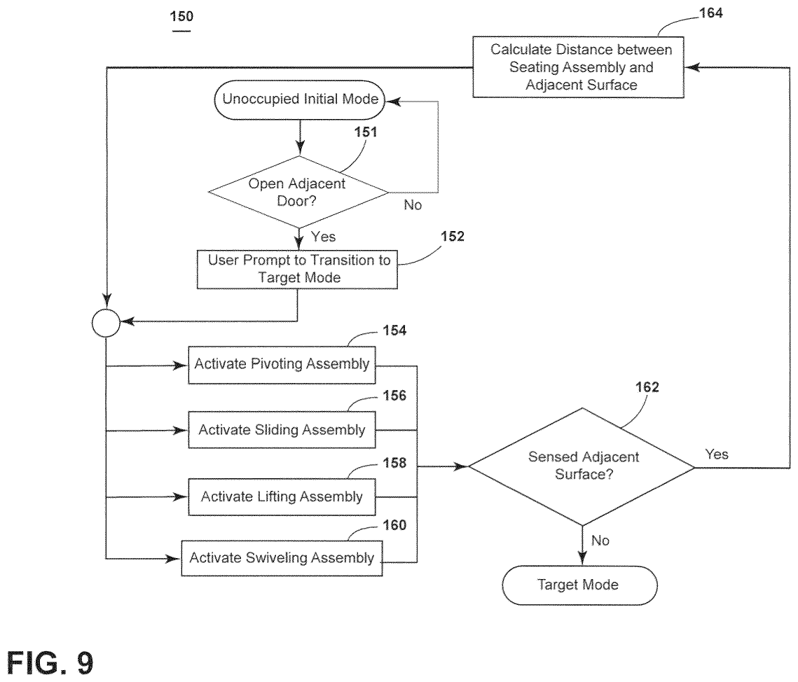

Referring now to FIG. 9, the flow chart demonstrates a second method of transitioning 150 the seating assembly 10. The second method of transitioning 150 may interchange the forward facing mode 42 for the rearward facing mode 44 and vice versa, so long as each mode transitions to the opposite mode of the forward facing mode 42 and the rearward facing mode 44. In other words, the method starts with the seating assembly in an initial mode and ends with the seating assembly in a target mode. According to some embodiments the first method of transitioning 100 may relate to transitioning the seating assembly 10 between the forward facing mode 42 and the rearward facing mode 44 when a door adjacent to the seating assembly 10 is in an open position. Additionally, or alternatively, the first method of transitioning 100 may comprise the step of detecting whether the seating assembly 10 is occupied (e.g., OCS mat, pressure sensor, etc.). When the seating assembly 10 is unoccupied, the first method of transitioning 100, may continue. The second method of transitioning 150 the seating assembly 10 comprises the step 152 of prompting the seating assembly 10 to transition to the opposite of the forward facing mode 42 and the rearward facing mode 44. The prompting can come from a user 86 speaking, a user 86 interacting with a HMI, a user 86 activating a switch, etc.

Still referring to FIG. 9, the second method of transitioning 150 also comprises a step 154 of activating the pivoting assembly 58, in response to the user 86 prompting the seating assembly 10 to transition modes. The step 154 of activating the pivoting assembly 58, in one example, changes the relative angle between the seat 14 and the seatback 16. In further reference to FIG. 9 the second method of transitioning 150 comprises a step 158 of activating the lifting assembly 62, in response to the user 86 prompting the seating assembly 10 to transition modes. The step 158 of activating the lifting assembly 62, in one example, changes the vertical position of the seating assembly 10. The step 158 may occur simultaneously to the step 154, as exemplified in FIG. 9. The step 158 may occur before the step 154. The step 158 may occur after the step 154. In even further reference to FIG. 8, the second method of transitioning 150 comprises a step 156 of activating the sliding assembly 60, in response to the user 86 prompting the seating assembly 10 to transition modes. The step 156 of activating the sliding assembly 60 slides the seating assembly 10 along the direction of extent of the slide track 30, in some examples, to arrive at the adjacent surface 38 and sense the adjacent surface 38 or to allow the configuration path 40 to end at the target mode (e.g., the forward facing mode 42 or the rearward facing mode 44). The step 156 may occur simultaneously to the step 154 and the step 158, as exemplified in FIG. 9. The step 156 may occur before the step 154 and the step 158. The step 156 may occur between the step 154 and the step 158. In other words, the step 154, the step 156, and the step 158 may occur simultaneously or in another order. The second method of transitioning 150 comprises a step 160 of activating the swiveling assembly 70. The swiveling assembly 70 rotates the seating assembly 10 along the vertical A-axis, in some examples, to arrive at the adjacent surface 38 and sense the adjacent surface 38 or to allow the configuration path 40 to end at the target mode (e.g., the forward facing mode 42 or the rearward facing mode 44).

The second method of transitioning 150 also comprises a step 162 of determining whether the seating assembly 10 arrived at the adjacent surface 38. The controller 24 determines whether the seating assembly 10 arrives at the adjacent surface 38 by sensing the adjacent surface 38 via a piezoelectric sensor, a pressure sensor, and/or various sensory devices that may be implemented or incorporated with the adjacent surface 38 and/or the seating assembly 10. As exemplified by FIG. 6, the sensor 20 may additionally, or alternatively, be coupled with the fourth actuator 56 to sense whether the fourth actuator 56 was able to allow the seating assembly 10 to swivel all the way to the target mode (e.g., the forward facing mode 42 or the rearward facing mode 44).

Referring still to FIG. 9, the second method of transitioning 150 comprises a step 164 of calculating the distance between the seating assembly 10 and the adjacent surface 38. In one example, the calculating of the distance is based on the distance the seating assembly 10 travels from the step 152 to arriving at the adjacent surface 38, where the controller 24 then senses the adjacent surface 38. The second method of transitioning 150 follows at least one of the step 154, the step 156, the step 158, and the step 160 until the controller 24 does not sense the adjacent surface 38, and the seating assembly 10, therefore, arrives at the target mode (e.g., the forward facing mode 42 or the rearward facing mode 44). In other words, the seating assembly 10 arrives at the adjacent surface 38 in a first configuration, then the controller 24 reconfigures the seating assembly 10 into a second configuration.

The rotatable seating assembly 10 with logic for vehicle 12 advantageously provides for a seating assembly 10 that can be implemented into a variety of vehicle types. The presently described seating assembly 10 rotates about a vertical A-axis while accommodating an adjacent surface 38. The seating assembly 10 allows a user 86 to occupy the seating assembly 10 in at least a forward facing mode 42 and a rearward facing mode 44 with few steps, in a quick transition.

Modifications of the disclosure will occur to those skilled in the art and to those who make or use the concepts disclosed herein. Therefore, it is understood that the embodiments shown in the drawings and described above are merely for illustrative purposes and not intended to limit the scope of the disclosure, which is defined by the following claims as interpreted according to the principles of patent law, including the doctrine of equivalents.

It will be understood by one having ordinary skill in the art that construction of the described concepts, and other components, is not limited to any specific material. Other exemplary embodiments of the concepts disclosed herein may be formed from a wide variety of materials, unless described otherwise herein.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A seating assembly for a vehicle, the seating assembly comprising:
a seat;
a seatback;
an actuator;
a sensor configured to sense an adjacent surface of the vehicle; and
a controller configured to receive the adjacent surface data from the sensor, wherein the controller is further configured to actuate the actuator to rotate the seating assembly between a forward facing mode and a rearward facing mode past the adjacent surface.

2. The seating assembly of claim 1, wherein the seating assembly further comprises:
a swiveling assembly comprising:
a mounting plate coupled with a slide track;
a base plate coupled with an interior floor of the vehicle; and
a swivel ring extending between the mounting plate and the base plate, wherein the swivel ring is coupled with a underside of the mounting plate, and further wherein the swivel ring is coupled with a top side of the base plate.

3. The seating assembly of claim 2, wherein the seating assembly further comprises:
a sliding assembly comprising the slide track, wherein the seating assembly slides relative to the slide track.

4. The seating assembly of claim 3, wherein the seating assembly further comprises:
a lifting assembly comprising:
the slide track;
a seat bracket; and
a lift arm extending between the slide track and the seat bracket, wherein the lift arm is coupled with the slide track and the seat bracket.

5. The seating assembly of claim 4, wherein the seating assembly further comprises a pivot member extending between the seat and the seatback, wherein the pivot member is coupled with the seat, and further wherein the pivot member is coupled with the seatback.

6. The seating assembly of claim 5, wherein the controller is configured to receive the adjacent surface data from the sensor, and further wherein the controller stores the data in a memory.

7. The seating assembly of claim 1, wherein the sensor comprises an imaging device configured to sense the adjacent surface via image capture.

8. The seating assembly of claim 1, wherein the sensor senses the adjacent surface when the seating assembly arrives at the adjacent surface.

9. The seating assembly of claim 8, wherein the sensor is operatively coupled with the actuator, and wherein the sensor senses when the actuator partially transitions the seating assembly between the forward facing mode and the rearward facing mode.

10. A seating assembly for a vehicle, the seating assembly comprising:
a pivoting assembly comprising:
a seatback coupled with a pivot member; and
a seat coupled with the pivot member, wherein the pivot member is coupled with a first actuator;
a lifting assembly comprising:
a slide track;
a seat bracket; and
a lift arm extending between the slide track and the seat bracket, wherein the lift arm is coupled with the slide track, the seat bracket, and a second actuator;
a sliding assembly comprising:
the slide track, wherein the slide track is coupled with a third actuator;
a swiveling assembly comprising:
a mounting plate coupled with the slide track;
a base plate coupled with the vehicle,
a swivel ring extending between the mounting plate and the base plate, wherein the swivel ring is coupled with a fourth actuator, wherein the swivel ring is coupled with a underside of the mounting plate, and further wherein the swivel ring is coupled with a top side of the base plate;
a sensor configured to sense an adjacent surface of the vehicle; and
a controller configured to receive adjacent surface data from the sensor, wherein the controller is configured to control the first actuator, the second actuator, and the third actuator to transition the seating assembly from an initial mode along a configuration path toward a target mode, and wherein the controller is configured to store the data of the adjacent surface of the vehicle in a memory.

11. The seating assembly according to claim 10, wherein the seating assembly further comprises an intermediate plate defining an aperture, wherein the swivel ring is disposed within the aperture of the intermediate plate.

12. The seating assembly of claim 10, wherein the sensor comprises an imaging device configured to sense the adjacent surface via image capture.

13. The seating assembly of claim 10, wherein the sensor senses the adjacent surface when the seating assembly arrives at the adjacent surface.

14. The seating assembly of claim 13, wherein the sensor is operatively coupled with at least one of the first actuator, the second actuator, the third actuator, the fourth actuator, and the adjacent surface.

15. A method for configuring a seating assembly within a vehicle, the method comprising:
identifying an adjacent surface within an interior of the vehicle in sensor data;
calculating a distance between the seating assembly and the adjacent surface in response to the seating assembly having a configuration, wherein the configuration is an occupiable seating configuration, and further wherein the occupiable seating configuration has a mode chosen from a forward facing mode and a rearward facing mode;
storing the distance between the seating assembly and the adjacent surface;
receiving a user input to transition the seating assembly from an initial mode chosen from the forward facing mode and the rearward facing mode toward a target mode opposite of the initial mode; and
controlling the configuration of the seating assembly to transition from one occupiable seating configuration mode chosen from the forward facing mode and the rearward facing mode toward the other of the forward facing mode and the rearward facing mode.

16. The method according to claim 15, further comprising:
identifying the adjacent surface data in image data, wherein the sensor is an image capturing sensor.

17. The method according to claim 15, further comprising:
detecting which mode of the forward facing mode and the rearward facing mode is the initial mode; and
in response to the mode being detected, activating a mode-specific transition of the seating assembly.

18. The method according to claim 15, further comprising:
identifying the adjacent surface in data in response to the seating assembly of a first configuration arriving at the adjacent surface.

19. The method according to claim 15, further comprising:
controlling the configuration of the seating assembly by controlling at least one of a seatback, a seat, an armrest, a headrest, a slide track, a lift arm, and swivel ring.

20. The method of according to claim 18, further comprising:
controlling the configuration of the seating assembly to a second configuration in response to the seating assembly arriving at the adjacent surface.
